(19) United States
(12) Patent Application Publication
(10) Pub. No.: US 2002/0060812 A1
(43) Pub. Date: May 23, 2002

(54) Image processing method and image processing apparatus

(76) Inventor: Hiroyuki Morimatsu, Kurume-shi (JP)

Correspondence Address: STEVENS, DAVIS, MILLER & MOSHER, L.L.P., Suite 850, 1615 L Street, N.W., Washington, DC, 20036, US

(21) Appl. No.: 09/985,617

(22) Filed: Nov. 5, 2001

(30) Foreign Application Priority Data
Nov. 10, 2000 (JP) 2000-343291

(51) Int. Cl. G06K 15/02; H04N 1/405; H04N 1/409; H04N 1/52; H04N 1/58

(52) U.S. Cl. 358/3.14; 358/532; 358/535; 358/3.15; 358/3.26

(57) ABSTRACT

An image processing method and apparatus for improving both gradation and resolution in a screening process. The apparatus comprises an image memory for storing multi-valued image data in pixel units; a pixel data acquiring portion for acquiring image pixel data from the memory; a threshold value matrix constituted by a density area by which dots of a high number of lines are produced and another density area by which dots of a low number of lines are produced; a threshold value data acquiring portion for acquiring from the matrix threshold value data corresponding to image data acquired by the pixel data acquiring portion based upon the image data address; and a comparator for comparing the acquired image data with the acquired threshold value data to thereby output a consequent binary signal.

### BACKGROUND OF THE INVENTION

The present invention generally relates to an image processing method and an image processing apparatus. More specifically, the present invention is directed to an image binary-processing technique enabling reproduction of multi-valued color image information as binary-coded images, and applicable to printers, scanners, copying machines, facsimile appliances, and the like.

Conventionally, the binary-processing method by the screening process operation has been proposed as one of methods enabling conversion of multi-valued images into binary-coded images. Now, the following description is made of the conventional image binary-processing technique by way of the screening process operation.

FIG. 6 is a schematic block diagram for indicating a conventional binary-processing apparatus by using the screening process operation. FIG. 7 is an explanatory diagram for explaining one example of a threshold value matrix employed in the binary-processing apparatus of FIG. 6.

In FIG. 6, image data 1 corresponds to such original image data having multi-values, which is required to be binary-processed. Normally, these data which are binary-processed so as to be used in printing apparatus correspond to such image data having four different color components made of black, cyan, magenta, and yellow.

Also, a threshold value matrix storage portion 3 stores thereinto such a matrix corresponding to the threshold value table shown in FIG. 7. This table is one of threshold value matrixes used in the case that gradation or density levels of the image data 1 own 256 gradations defined from “0” to “255.” Conventionally, this matrix data is designed in such a manner that dots are regularly arrayed based upon a certain generation rule.

In a comparator 2, data “D” is acquired from the image data 1. This input data “D” corresponds to density data of each pixel of each color component contained in the image data. Also, threshold value data “T” corresponding to a coordinate value of this acquired pixel data is input from the threshold hold matrix storage means 3 into the comparator 2. Then, this comparator 2 compares the pixel data “D” with the threshold value data “T.” When D>T, the comparator 2 sets a binary-processed result “Q” to 1, namely outputs a binary signal as an ON-dot. Conversely, when D<T, the comparator 2 sets a binary-processed result Q to 0, namely outputs another binary signal as an OFF-dot.

Then, the above-described binary process operation is carried out with respect to all of the pixel data of the respective color components which constitute the image data 1 (namely, original data), so that desirable binary-processed image data may be finally produced.

The above-described binary-processed image which is produced by way of the conventional screening technique owns such a problem that both gradation and resolution are incompatible with each other.

In other words, generally speaking, in order to improve the gradation, such a screen in which the generation period, or the generation interval of the dot by the concentrated dot (cluster of plural dots) to be produced is long is applied to the input image. As a result, the reproducibility of the dots in the printing result is stabilized, so that the gradation may be improved. However, since the diameters of the produced dots are enlarged, edge deterioration called as “jaggy” occurs in the edge portion, which may considerably lower the resolution.

Conversely, in order to improve the resolution, such a screen in which the generation period, or the interval of the dot by the concentrated dot to be produced is short is applied to the input image. As a result, since the diameters of the produced dots are reduced, the reproducibility at the edge portion may be improved. However, in the flat area, the reproducibility of the printed dots is considerably lowered. Also, since the dot saturation occurs in the intermediate/high density areas, the reproducibility of the gradation is largely deteriorated.

### SUMMARY OF THE INVENTION

The present invention has been made to solve the above-described problem, and therefore, has a general object to provide an image processing technique enabling improvements on both gradation and resolution in a screening process operation.

In accordance with a first aspect of the present invention, a first image processing method is provided which comprises the steps of:

storing in a memory multi-valued image data in a unit of pixel;

preparing a threshold value matrix constituted by a first threshold density area for production of high line number defining dots and a second threshold density area for production of low line number defining dots;

acquiring multi-valued image data stored in said memory;

acquiring from said matrix threshold density value based upon an address of the image data acquired from said memory and corresponding thereto; and

comparing the acquired image data with the acquired threshold density value to thereby output a consequent binary signal.

In accordance with this first image processing method, the dots can be produced in the dot generation periods enabling achievement of a much higher stability of the printing dots and also achieving the superior reproducibility of the edges in response to the density area. As a result, the printing data having both the superior gradation and the superior resolution can be produced.

In accordance with a second aspect of the present invention, a second image processing method is provided according to the above first method, wherein the first threshold density area corresponds to a low density area of an input image, and the second threshold density area corresponds to an intermediate/high density area of the input image. According to this second method, dots having small diameters are produced in the low density area, the dot generation period of which is short, whereas, dots having large diameters are produced in the intermediate/high density areas, the dot generation period of which is long. As a consequence, both the gradation and the resolution may be improved in the dot printing.

In accordance with a third aspect of the present invention, a third image processing method is provided according to the above first or second method, wherein in the density area in which the high line number defining dots are produced, such a binary-processed result is outputted by which the dots are arranged in a non-periodic manner; and in the density area in which the low line number defining dots are produced, such a binary-processed result is outputted by which the dots are arranged in a periodic manner. According to this third method, the dots are arranged in the non-periodic manner in the low density area of the acquired image, so that lowering of the edge reproducibility may be suppressed. Also, the dots are arranged in the periodic manner in the intermediate/high density areas of the image, so that the saturation of the dots may be reduced. As a result, both the gradation and the resolution by the dot printing may be improved.

In accordance with a fourth aspect of the present invention, a fourth image processing method is provided according to any one of the above first to third methods, wherein low line number defining dots are produced by coupling high line number defining dots to each other. According to this fourth method, the high line number defining dots are coupled to each other from a certain density level, so that diameters of the dots are enlarged, and these dots are produced in such density levels exceeding the certain level, which are intermediate and high density levels. As a consequence, both the gradation and the resolution by the dot printing may be improved.

In accordance with a fifth aspect of the present invention, a first image processing apparatus is provided which comprises: an image memory for storing multi-valued image data; pixel data acquiring means for acquiring image data which is stored in the image memory in the unit of a pixel; threshold value matrix storage means for storing a threshold value matrix constituted by a first threshold density area for production of high line number defining dots, and a second threshold density area for production of low line number defining dots; means for acquiring multi-valued image data stored in the image memory; threshold value data acquiring means for acquiring from the matrix storage means threshold value data based upon an address of the acquired image data and corresponding thereto; and a comparator for comparing the acquired image data with the acquired threshold value data to thereby output a consequent binary signal. According to this first image processing apparatus, the dots can be produced in the dot generation periods enabling achievement of a much higher stability in the printing dots and also achievement of a superior reproducibility of the edges in response to the density area. As a result, the printing data having both the superior gradation and the superior resolution can be produced.

In accordance with a sixth aspect of the present invention, a second image processing apparatus is provided which comprises the above first apparatus, wherein the first threshold density area corresponds to an area of low density levels of the image, and the second threshold density area corresponds to areas of intermediate and high density levels of the image. According to this second apparatus, dots having small diameters are produced in the low density area, the dot generation period of which is short, whereas, dots having large diameters are produced in the intermediate density and high density areas, the dot generation period of which is long. As a consequence, both the gradation and the resolution may be improved in the dot printing.

In accordance with a seventh aspect of the present invention, a third image processing apparatus is provided which comprises the above first or second apparatus, wherein in the density area where the high line number defining dots are produced, such a binary-processed result is outputted by which the dots are arranged in a non-periodic manner; and in the density area in which the low line number defining dots are produced, such a binary-processed result is outputted by which the dots are arranged in a periodic manner. According to this third apparatus, the dots are arranged in the non-periodic manner in the low density area of the image, so that lowering of the edge reproducibility may be suppressed. Also, the dots are arranged in the periodic manner in the intermediate density and high density areas, so that the saturation of the dots may be reduced. As a result, both the gradation and the resolution by the dot printing may be improved.

In accordance with an eighth aspect of the present invention, a fourth image processing apparatus is provided which comprises any one of the above first to third apparatuses, wherein low line number defining dots are produced by coupling high line number defining dots to each other. According to this fourth apparatus, the high line number defining dots are coupled to each other from a certain density level, so that diameters of the dots are enlarged, and these dots are produced in such density levels exceeding the certain level, which are intermediate density and high density levels. As a consequence, both the gradation and the resolution by the dot printing may be improved.

### BRIEF DESCRIPTION OF THE DRAWINGS

For a better understanding of the present invention, reference is made of a detailed description in conjunction with the accompanying drawings in which:

FIG. 1 is a schematic block diagram showing an arrangement of an image processing apparatus according to an embodiment of the present invention;

FIG. 2 is a flow chart showing image processing operations of the apparatus shown in FIG. 1;

FIG. 3 is an explanatory diagram for explaining a structure of cells for producing a dot in the image processing apparatus of FIG. 1;

FIG. 4 is an explanatory diagram for explaining threshold value data which are set in a threshold value matrix provided in the apparatus of FIG. 1;

FIG. 5 is an explanatory diagram for explaining shapes of dots produced by the apparatus of FIG. 1;

FIG. 6 is a schematic block diagram showing the conventional binary-processing apparatus operated by the screening method; and

FIG. 7 is an explanatory diagram for explaining an example of the threshold value matrix employed in the conventional apparatus of FIG. 6.

### DESCRIPTION OF THE EMBODIMENTS

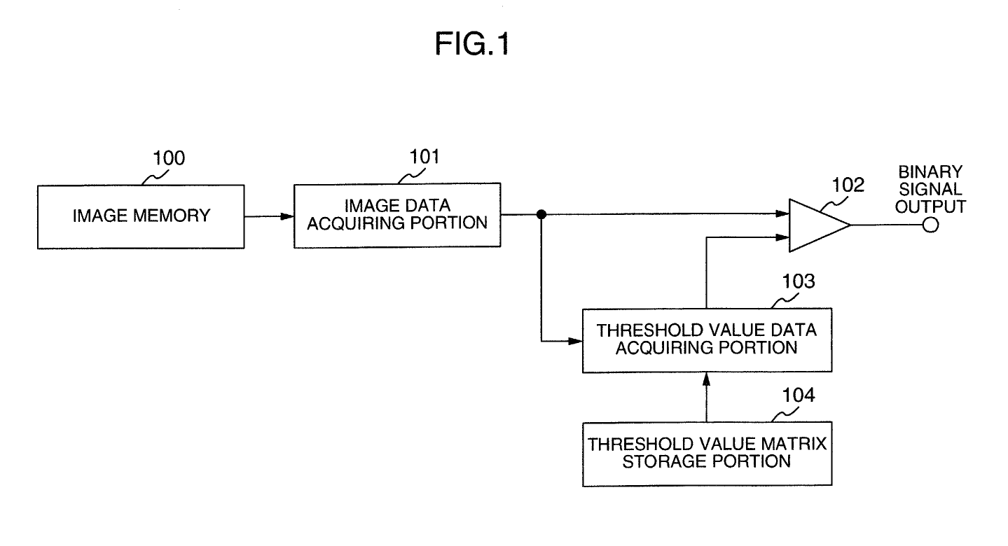

Referring now to FIG. 1 to FIG. 5, one embodiment of the present invention is described. It should be understood that the same reference numerals shown in these drawings will be employed as those for denoting the same, or similar structural elements, and therefore, descriptions thereof are made only one time.

As indicated in FIG. 1, an image processing apparatus, according to an embodiment mode of the present invention, is provided with an image memory 100, a picture data acquiring portion 101, a comparator 102, a threshold value data acquiring portion 103, and also a threshold value matrix storing portion 104. The image memory 100 stores thereinto image data having multi-values, which should be binary-processed. The pixel data acquiring portion 101 acquires the image data stored in the image memory 100 in the unit of a pixel. The threshold value matrix storing portion 104 stores thereinto a predetermined threshold value matrix. The threshold value data acquiring portion 103 acquires from the threshold value matrix storing portion 104, such threshold value data corresponding to image data input from the pixel data acquiring portion 101 and based upon an address of the input image data. The comparator 102 compares the image data input from the pixel data acquiring portion 101 in the unit of a pixel with the threshold value data input from the threshold value data acquiring portion 103 to output a corresponding binary signal. Herein word “portion” is used to represent such means as circuit, element, device, etc.

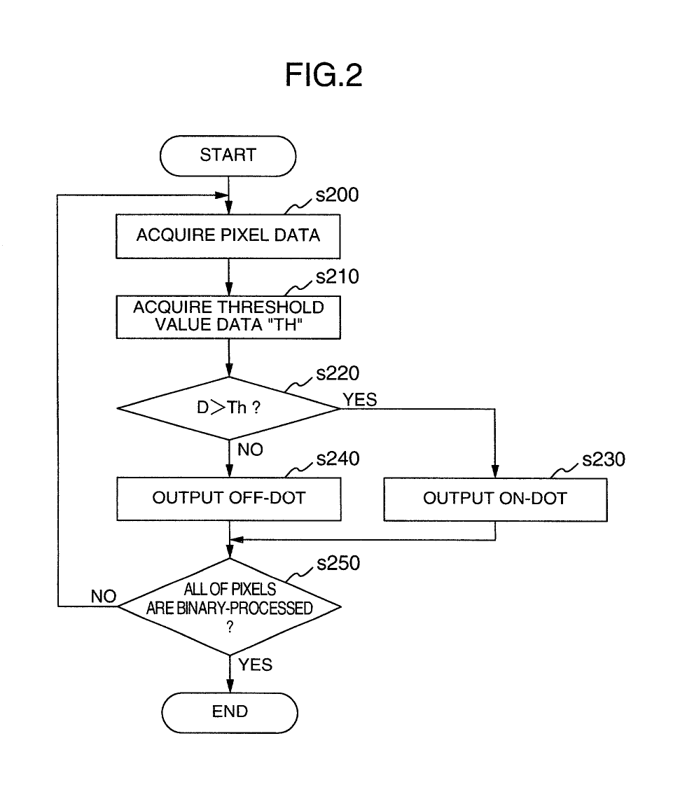

Referring now to a flow chart indicated in FIG. 2, image processing operations of the image processing apparatus arranged as mentioned above are described.

First, data “D” (namely, color density value or gradation level ) in the unit of a pixel is acquired from the image data stored in the image memory 100 in response to a memory address by the pixel data acquiring portion 101 (step s200). Threshold value data “Th” of the threshold value matrix stored in the threshold value matrix storing portion 104, corresponding to an address of the acquired pixel data “D”, is acquired by the threshold value data acquiring portion 103 (step s210) It should be noted that a portion for generating a used threshold matrix will be discussed later.

Next, the acquired pixel data “D” is compared with the acquired threshold value data “Th” by the comparator 102 (step s220). When the comparison result is equal to D>T, the comparator 102 outputs binary data as an ON-dot (step S230). When the comparison result is equal to D≦Th, the comparator 102 outputs binary data as an OFF-dot (step s240). The above-described process operation is carried out with respect to all of pixels contained in the input image data, and thereafter, this process operation is accomplished (step s250).

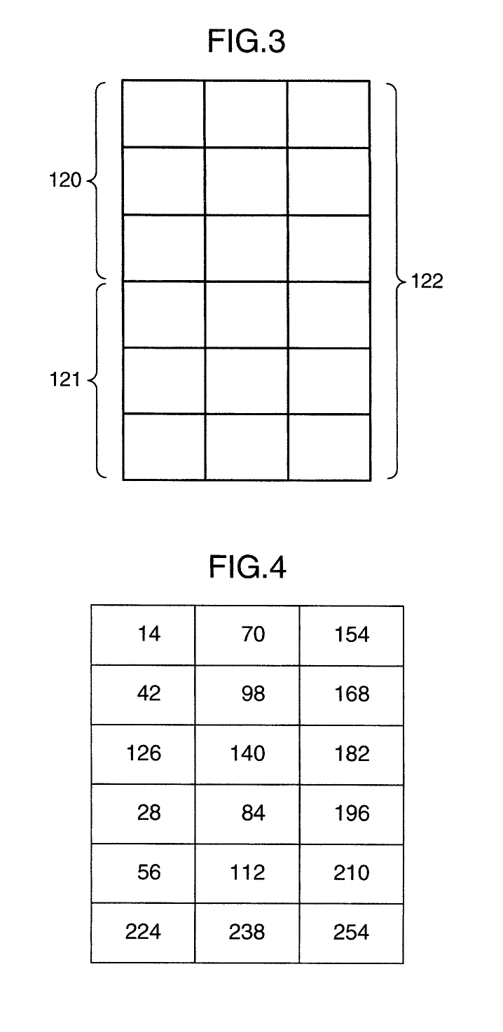

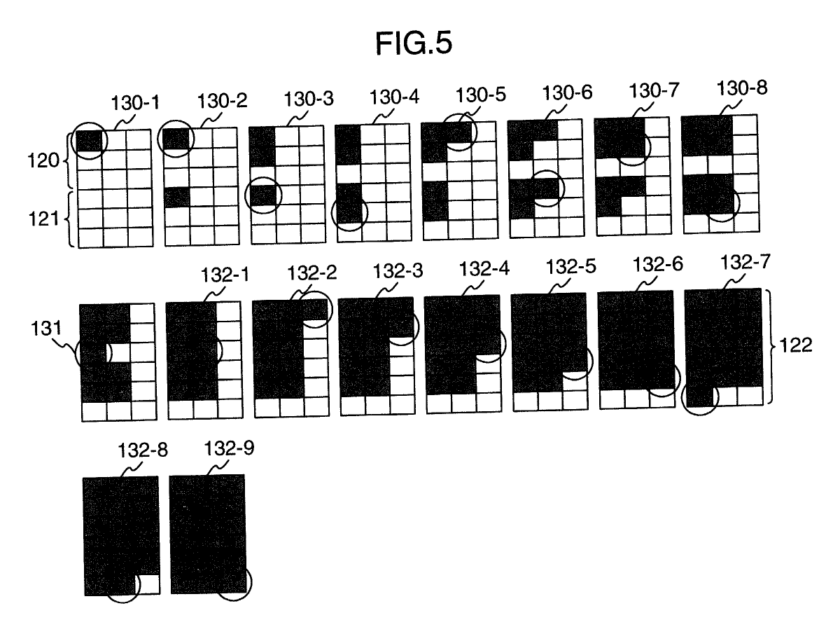

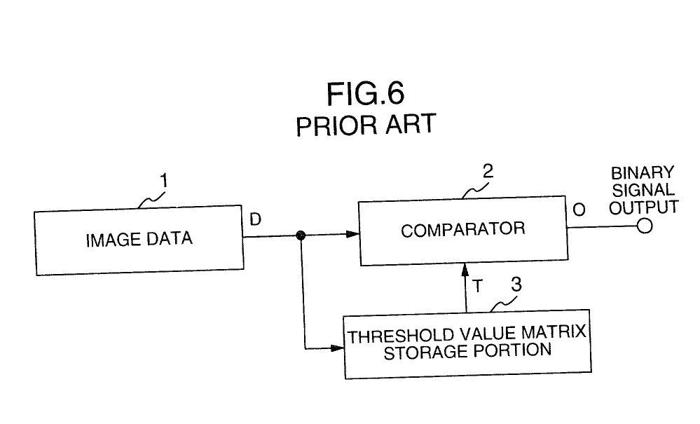

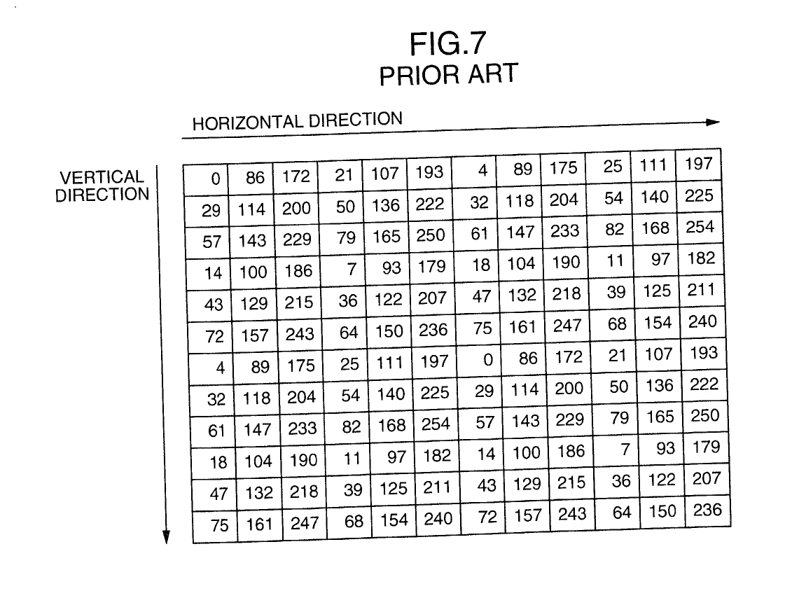

Next, setting of threshold values contained in the threshold value matrix will now be explained with reference to FIG. 3. In FIG. 3, reference numerals 120 and 121 show an example of two high line number cells. These high line number cells 120 and 121 produce high line numbers of dots, the generation periods of which are short. The generation period of the dot is equal to a generation interval. In this example, one square-like-shape portion segmented by a wide or thick line indicates one pixel, and each of these high line number cells is constructed by 3×3 pieces of pixels. Also, reference numeral 122 represents an example of one low line number cell. This low line number cell 122 produces a low line number of dots, the generation period of which is long. This low line number cell 122 is arranged by containing the high line number cells 120 and 121. While the respective cells shown in FIG. 3 are employed, the pixel data “D” in the unit of the pixel is processed in accordance with the following method to produce binary-processed data (dots) such as indicated in FIG. 5. In the case, the expression “line number” indicates a total number of (ON) dots which are formed on a screen per 1 inch, namely “lines/inch.”

With respect to the high line number cells 120 and 121, the growth of dots is carried out within the respective high line number cells in a low density area of the input image; the dots produced within the high line number cell 120 and the high line number cell 121 are coupled to each other from a certain density level and the further growth of dots are carried out within the low line number cell 122.

FIG. 4 represents one example of a matrix for the threshold value “Th” used to produce such dots. In this example, values of the threshold values “Th” are indicated which correspond to pixels of respective addresses, and FIG. 4 shows the threshold values “Th” which correspond to 3×6 pieces of pixels (addresses) shown in FIG. 3 and FIG. 5.

In FIG. 4, the growth of dots are carried out within the high line number cells 120 and 121 until the density value “D” of the input image is equal to 126 (namely, D=126); when the density value of the input image becomes higher than this density value of 126, the dots of the high line number cell 120 are coupled to the dots of the high line number cell 121, and dots are produced in a low line number within the low line number cell 122.

FIG. 5 illustratively shows binary-processed dot shapes every density level which has been binary-processed by the threshold value matrix indicated in FIG. 4. In FIG. 5, such a pixel is indicated in a black color as a result that each of the pixel data “D” is compared with a threshold value “Th” corresponding to an address of this pixel data “D”, and the comparison result becomes an ON-dot output indicated by such a black color.

Reference numerals 130-1 to 130-8 show an example of shapes of high line number dots which are produced by employing the high line number cells 120 and 121. In FIG. 5, such dots are indicated by circle marks, which are produced in the ascent order of low threshold values of 14, 28, 42, - - - , 84, 98, and 120, which are lower than the threshold value “Th” =126 indicated in FIG. 4 (namely, FIG. 5 illustratively shows progress conditions of dot production or growth). Also, reference numeral 131 shows an example of a shape of coupling start dot (corresponding to pixel of Th=126) in the case that coupling of the high line number dots 130-8 is commenced. Reference numbers 132-1 to 132-9 represent an example of shapes of low line number dots which are produced within the low line number cell 122 after coupling of the high line number dots 130. The coupling start dot shape 131 adds a dot to such a portion where the dot produced in the high line number cell 120 is coupled to the dot produced in the high line number cell 121. Similar to the above-described dot production in the high line number cell, such dots which are produced by employing the low line number cell 122 are produced in the ascent order of high threshold values of 140, 154, 168, - - - , 224, 238, and 252, which are higher than the threshold value Th=126. These produced dots are also indicated by circular marks in FIG. 5. With respect to the low line number dot shapes 131 and 132-1 to 132-9, dot generation periods thereof along sub-scanning directions (namely, longitudinal (or up and down) directions as viewed in FIG. 5 drawing) are equal to ½ of the dot generation period of the high line number dot 130. In other words, the high line number cells 120 and 121 used to produce the high line number dots are formed, in the longitudinal direction of the drawing, by three pixels employed as one unit. Whereas the low line number cell 122 used to produce the low line number dots is formed, in the longitudinal direction of the drawing, by six pixels employed as one unit. Based upon one sort of threshold value matrix, dots can be produced in two sorts of line numbers by selectively using the high line number cell or the low line number cell, in response to a density (area) change in pixel data. Namely, in a low density area, high line number dots, whose dot generation period is short are produced. In an intermediate density area and a high density area, low line number dots whose dot generation period is long are produced.

In this embodiment mode, each of high line number cells 120 and 121 is formed of 3×3 pixels, and low line number cell 122 is formed of 3×6 pixels. However, these cell sizes (namely, total number of pixels which constitute cell) may be arbitrarily set. In order to produce such a threshold value matrix for a larger cell size, it is possible to constitute such a matrix having the above-explained feature and based upon certain another rule.

The use of threshold value matrix of FIG. 4 gives rise to one sort of periodic characteristic with respect to the dot coordinate values. Alternatively, in producing high line dots, it is possible to improve resolution by arranging produced dots by selecting their coordinates values in a non-periodic manner. While, for intermediate/high density area of the input image, it is possible to secure a gradation by maintaining a certain regularity by a periodic disposition or arrangement of produced dots.

Furthermore, in the threshold value matrix employed in the above embodiment mode, two different sorts of line numbers are involved. Alternatively, by using such a threshold value matrix having coupling patterns of 3 sorts or 4 sorts of dots, it is possible to produce dots of more than two sorts of line numbers.

As previously described, in accordance with this embodiment mode, both the gradation and the resolution can be improved in the screening process operation in such a way that the dots of two line numbers are produced by employing the cells having the various cell sizes in response to the density of the pixel data contained in the input image.

As previously explained, in accordance with the present invention, the dots can be produced in the dot generation periods enabling achievement of a higher stability of the printing dots and also achievement of a higher superior reproducibility of the edges in response to a density of the input image area. As a result, the image processing apparatus of the present invention can achieve such an effective effect that the printing data having both the superior gradation and the superior resolution can be produced.

Also, assuming now that such a density area where dots of high line numbers(i.e., high line number defining dots) are produced corresponds to a low density area of an input image and that such a density area where dots of low line numbers(i.e., low line number defining dots) are produced corresponds to intermediate/high density areas, dots having small diameters are produced in the low density area, the dot generation period of which is short, whereas, dots having large diameters are produced in the intermediate/high density areas, the dot generation period of which is long. As a consequence, the image processing apparatus of the present invention can achieve such an advantageous effect that both the gradation and the resolution obtainable by the dot printing are improved.

Since such binary-processed results are outputted by which dots are arranged in a non-periodic manner in such a density area where dots of high line numbers are produced, and also such binary-processed results are outputted by which dots are arranged in a periodic manner in such a density area where dots of low line numbers are produced, the dots are arranged in a non-periodic manner in the low density area, so that lowering of the edge reproducibility may be suppressed. Also, the dots are arranged in the periodic manner in the intermediate/high density areas, so that the saturation of the dots may be reduced. As a result, the image processing apparatus of the present invention can achieve such an advantageous effect that both the gradation and the resolution obtainable by the dot printing are improved together.

If the dots of the low line numbers are produced by the coupling of dots of high line numbers, then the high line number defining dots are coupled to each other from a certain density level, so that diameters of the dots are enlarged, and these dots are produced in such density levels exceeding the certain level, which are intermediate and high density levels. As a consequence, both the gradation and the resolution by the dot printing may be improved.

The above-described embodiment examples are illustrative of the principles of the present invention. Various modifications or choices could be effected by those skilled in the art.

What is claimed is:

1. An image processing method comprising the steps of:
preparing a threshold value matrix constituted by a density area by which dots of a high number of lines are produced and another density area by which dots of a low number of lines are produced;
acquiring multi-valued image data which is stored in an image memory in the unit of a pixel;
acquiring threshold value data from the threshold value matrix based upon an address of said acquired image data and corresponding thereto; and
comparing the acquired image data in the pixel unit with the acquired threshold value data to thereby output a binary signal.

2. An image processing method as claimed in claim 1, wherein
said density area by which the dots of the high number of lines are produced corresponds to a low density area of an input image, and said density area by which the dots of the low number of lines are produced corresponds to intermediate/high density areas of the input image.

3. An image processing method as claimed in claim 1, wherein
in said density area by which the dots of the high number of lines are produced, such a binary-processed result is outputted by which the dots are arranged in a non-periodic manner; and in said density area by which the dots of the low number of lines are produced, such a binary-processed result is outputted by which the dots are arranged in a periodic manner.

4. An image processing method as claimed in claim 1 wherein:
dots of the low number of lines are produced by coupling dots of high numbers of lines to each other.

5. An image processing apparatus comprising:
an image memory for storing multi-valued image data;
pixel data acquiring means for acquiring image data stored in a unit of pixel in said image memory;
threshold value matrix storage means for storing a threshold value matrix constituted by a first density area by which dots of a high number of lines are produced, and a second density area by which dots of a low number of lines are produced;
threshold value data acquiring means for acquiring, from said matrix storage means, threshold value data based upon an address of said input image data and corresponding thereto; and
a comparator for comparing the acquired image data with the acquired threshold value data to thereby output a consequent binary signal.

6. An image processing apparatus as claimed in claim 5, wherein
said first density area of said matrix corresponds to a low density area of the stored input image; and said second density area of said matrix corresponds to intermediate/high density area of the stored input image.

7. An image processing apparatus as claimed in claim 5, wherein
in said first density area of said matrix, said comparator sequentially outpts consequent binary signals for non-periodic production of dots; and in said second density area of said matrix, said comparator sequentially consequent binary signals for periodic production of dots.

8. An image processing apparatus as claimed in claim 6, wherein
in said first density area of said matrix, said comparator sequentially outputs consequent binary signals for non-periodic production of dots; and in said second density area of said matrix, said comparator sequentially outputs consequent binary signals for periodic production of dots.

9. An image processing apparatus as claimed in claim 7, wherein
dots of the low number of lines are produced by coupling dots of the high numbers of lines to each other.

10. An image processing apparatus as claimed in claim 8, wherein
dots of the low number of lines are produced by coupling dots of the high number of lines to each other.
